(19) United States
(12) Patent Application Publication
(10) Pub. No.: US 2020/0374112 A1
(43) Pub. Date: Nov. 26, 2020

(54) Secure Provisioning of Data to Client Device

(71) Applicant: Huawei Technologies Co., Ltd., Shenzhen (CN)

(72) Inventors: Sampo Sovio, Helsinki (FI); Qiming Li, Helsinki (FI); Pekka Laitinen, Helsinki (FI); Gang Lian, Helsinki (FI); Meilun Xie, Beijing (CN); Xiwen Fang, Shanghai (CN); Zhihua Shan, Shenzhen (CN)

(21) Appl. No.: 16/768,501

(22) PCT Filed: Dec. 1, 2017
(86) PCT No.: PCT/EP2017/081203

§ 371 Date: May 29, 2020

(51) Int. Cl. H04L 9/08; H04L 9/30; H04L 29/06

(52) U.S. Cl. CPC H04L 9/0841; H04L 63/0442; H04L 9/3073

(57) ABSTRACT

In a method for secure provisioning of data to a client device, a non-trusted manufacturing facility is equipped with a secure server device to establish a secure data provisioning channel from the secure server device to trusted hardware in client devices without the secure server device and the client devices needing to have a shared secret.

### TECHNICAL FIELD

The present application relates to the field of cryptography, and more particularly to secure provisioning of data to a client device, and related devices, methods and computer programs.

### BACKGROUND

Data may need to be provisioned to mobile and wearable devices during device manufacturing. Such data may include various asset data, including but not limited to: device key pairs, other cryptographic key material, digital certificates, security policies, device identifiers and credentials. Device key pairs are typically required e.g. to enable various security services offered by the mobile/wearable device. Additionally/alternatively, such data may include executable code, e.g. a Trusted Application (TA). The provisioned data is typically protected in some manner by the mobile/wearable device's secure hardware.

As an example, during device manufacturing at the factory, a device key pair may be generated and its public key certified by enrolling a device certificate for it. Both the device key pair and the device certificate may be placed in a secure location in the device to enable the usage of the private key to be tightly controlled. Typically, the device key pair can be used only for predefined use cases when the device is with an end-user. These use cases include e.g. device attestation in which the device can sign an attestation to prove that a certain parameters are valid for the device. Another example is key attestation where a key pair is generated by a secure environment in the device, and the device key pair is then used to attest that the key pair in question is really generated in and protected by the secure environment of the device.

However, provisioning of data (such as device keys or device key pairs and the like) in a client device during device manufacturing can have security issues, such as how to encrypt the data to be provisioned so that only the target client device is able to decrypt the data.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

It is an object of the disclosure to provide improved secure provisioning of data to a client device. The foregoing and other objects are achieved by the features of the independent claims. Further implementation forms are apparent from the dependent claims, the description and the figures.

According to a first aspect, a secure server device is provided. The secure server device comprises an interface configured to obtain a public key of a provisioning asymmetric cryptographic key pair, the provisioning asymmetric cryptographic key pair having been generated based on a first symmetric cryptographic key of a client device class identifier. The secure server device further comprises a processor configured to utilize the obtained public key of the provisioning asymmetric cryptographic key pair in generation of a second symmetric cryptographic key, and utilize the generated second symmetric cryptographic key in encryption of data to be provisioned to one or more client devices associated with the class identifier. The interface is further configured to send the encrypted data to be provisioned to one or more of the client devices associated with the class identifier. The embodiment allows a non-trusted manufacturing facility equipped with the secure server device to establish a secure data provisioning channel from the secure server device to trusted hardware in client devices, thereby avoiding security issues associated with provisioning of data in the client device during device manufacturing.

In a further implementation form of the first aspect, the processor is further configured to generate an ephemeral asymmetric cryptographic key pair, and to generate the second symmetric cryptographic key based on the obtained public key of the provisioning asymmetric cryptographic key pair and a private key of the generated ephemeral asymmetric cryptographic key pair using a predetermined key-agreement protocol, and the interface is further configured to send a public key of the generated ephemeral asymmetric cryptographic key pair to the one or more of the client devices associated with the class identifier. Using the private key of the ephemeral asymmetric cryptographic key pair together with the public key of the provisioning asymmetric cryptographic key pair allows a secure way of establishing a shared secret (i.e. the second symmetric cryptographic key) between the secure server device and the client device.

In a further implementation form of the first aspect, the data to be provisioned comprises at least one of cryptographic key material or executable code.

In a further implementation form of the first aspect, the provisioning asymmetric cryptographic key pair comprises an elliptic curve key pair or a Rivest-Shamir-Adleman key pair. Using the elliptic curve key pair or the Rivest-Shamir-Adleman key pair as the provisioning asymmetric cryptographic key pair allows further improvements in security for the generation of the second symmetric cryptographic key.

In a further implementation form of the first aspect, the predetermined key-agreement protocol comprises a Diffie-Hellman key-agreement protocol. Using a key-agreement protocol such as the Diffie-Hellman key-agreement protocol allows further improvements in security for the generation of the second symmetric cryptographic key.

In a further implementation form of the first aspect, the Diffie-Hellman key-agreement protocol comprises an elliptic curve Diffie-Hellman key-agreement protocol. Using the elliptic curve Diffie-Hellman key-agreement protocol allows further improvements in security for the generation of the second symmetric cryptographic key.

In a further implementation form of the first aspect, the secure server device further comprises a hardware security module. Using a hardware security module in the secure server device allows a secure and certified environment against physical and logical attacks.

According to a second aspect, a secure server device is provided. The secure server device comprises an interface configured to obtain a public key of a provisioning asymmetric cryptographic key pair, the provisioning asymmetric cryptographic key pair having been generated based on a first symmetric cryptographic key of a client device class identifier. The secure server device further comprises a processor configured to utilize the obtained public key of the provisioning asymmetric cryptographic key pair in generation of a second symmetric cryptographic key, randomly generate a third symmetric cryptographic key, encrypt data to be provisioned to one or more client devices associated with the class identifier with the randomly generated third symmetric cryptographic key, and utilize the generated second symmetric cryptographic key in encryption of the third symmetric cryptographic key. The interface is further configured to send the encrypted data to be provisioned and the encrypted third symmetric cryptographic key to one or more of the client devices associated with the class identifier. The embodiment allows a non-trusted manufacturing facility equipped with the secure server device to establish a secure data provisioning channel from the secure server device to trusted hardware in client devices, thereby avoiding security issues associated with provisioning of data in the client device during device manufacturing.

In a further implementation form of the second aspect, the processor is further configured to generate an ephemeral asymmetric cryptographic key pair, and to generate the second symmetric cryptographic key based on the obtained public key of the provisioning asymmetric cryptographic key pair and a private key of the generated ephemeral asymmetric cryptographic key pair using a predetermined key-agreement protocol, and the interface is further configured to send a public key of the generated ephemeral asymmetric cryptographic key pair to the one or more of the client devices associated with the class identifier. Using the private key of the ephemeral asymmetric cryptographic key pair together with the public key of the provisioning asymmetric cryptographic key pair allows a secure way of establishing a shared secret (i.e. the second symmetric cryptographic key) between the secure server device and the client device.

In a further implementation form of the second aspect, the processor is further configured to utilize white-box cryptography in the encryption of the generated third symmetric cryptographic key. In other words, the embodiment can be applied together with existing protection methods, such as white-box encryption.

In a further implementation form of the second aspect, the data to be provisioned comprises at least one of cryptographic key material or executable code.

In a further implementation form of the second aspect, the provisioning asymmetric cryptographic key pair comprises an elliptic curve key pair or a Rivest-Shamir-Adleman key pair. Using the elliptic curve key pair or the Rivest-Shamir-Adleman key pair as the provisioning asymmetric cryptographic key pair allows further improvements in security for the generation of the second symmetric cryptographic key

In a further implementation form of the second aspect, the predetermined key-agreement protocol comprises a Diffie-Hellman key-agreement protocol. Using a key-agreement protocol such as the Diffie-Hellman key-agreement protocol allows further improvements in security for the generation of the second symmetric cryptographic key.

In a further implementation form of the second aspect, the Diffie-Hellman key-agreement protocol comprises an elliptic curve Diffie-Hellman key-agreement protocol. Using the elliptic curve Diffie-Hellman key-agreement protocol allows further improvements in security for the generation of the second symmetric cryptographic key.

In a further implementation form of the second aspect, the secure server device further comprises a hardware security module. Using a hardware security module in the secure server device allows a secure and certified environment against physical and logical attacks.

According to a third aspect, a client device is provided. The client device comprises a secure storage configured to store a first symmetric cryptographic key of a client device class identifier associated with the client device. The client device further comprises a transceiver configured to receive from a secure server device encrypted data to be provisioned to the client device. The client device further comprises a processor configured to obtain a private key of a provisioning asymmetric cryptographic key pair, the provisioning asymmetric cryptographic key pair having been generated at the client device based on the stored first symmetric cryptographic key, utilize the obtained private key of the provisioning asymmetric cryptographic key pair in generation of a second symmetric cryptographic key, and utilize the generated second symmetric cryptographic key in decryption of the encrypted data to be provisioned. The embodiment allows a secure data provisioning channel to be established between trusted hardware in the client device and a non-trusted manufacturing facility equipped with the secure server device, thereby avoiding security issues associated with provisioning of data in the client device during manufacturing of the client device.

In a further implementation form of the third aspect, the transceiver is further configured to receive from the secure server device a public key of an ephemeral asymmetric cryptographic key pair, and the processor is further configured to generate the second symmetric cryptographic key based on the private key of the generated provisioning asymmetric cryptographic key pair and the received public key of the ephemeral asymmetric cryptographic key pair using a predetermined key-agreement protocol. Using the public key of the ephemeral asymmetric cryptographic key pair together with the private key of the provisioning asymmetric cryptographic key pair allows a secure way of establishing a shared secret (i.e. the second symmetric cryptographic key) between the client device and the secure server device.

In a further implementation form of the third aspect, the client device further comprises a trusted execution environment configured to perform cryptographic operations. Use of trusted execution environment allows class secret and provisioning key derivation to be protected in the client devices.

According to a fourth aspect, a client device is provided. The client device comprises a secure storage configured to store a first symmetric cryptographic key of a client device class identifier associated with the client device. The client device further comprises a transceiver configured to receive from a secure server device encrypted data to be provisioned to the client device. The client device further comprises a processor configured to obtain a private key of a provisioning asymmetric cryptographic key pair, the provisioning asymmetric cryptographic key pair having been generated at the client device based on the stored first symmetric cryptographic key, utilize the obtained private key of the provisioning asymmetric cryptographic key pair in generation of a second symmetric cryptographic key, utilize the generated second symmetric cryptographic key in decryption of an encrypted third symmetric cryptographic key, and utilize the decrypted third symmetric cryptographic key in the decryption of the data to be provisioned, the encrypted third symmetric cryptographic key having been received from the secure server device by the transceiver. The embodiment allows a secure data provisioning channel to be established between trusted hardware in the client device and a non-trusted manufacturing facility equipped with the secure server device, thereby avoiding security issues associated with provisioning of data in the client device during manufacturing of the client device.

In a further implementation form of the fourth aspect, the transceiver is further configured to receive from the secure server device a public key of an ephemeral asymmetric cryptographic key pair, and the processor is further configured to generate the second symmetric cryptographic key based on the private key of the generated provisioning asymmetric cryptographic key pair and the received public key of the ephemeral asymmetric cryptographic key pair using a predetermined key-agreement protocol. Using the public key of the ephemeral asymmetric cryptographic key pair together with the private key of the provisioning asymmetric cryptographic key pair allows a secure way of establishing a shared secret (i.e. the second symmetric cryptographic key) between the client device and the secure server device.

In a further implementation form of the fourth aspect, the processor is further configured to utilize white-box cryptography in the decryption of the received encrypted third symmetric cryptographic key. In other words, the embodiment can be applied together with existing protection methods, such as white-box encryption.

In a further implementation form of the fourth aspect, the client device further comprises a trusted execution environment configured to perform cryptographic operations. Use of trusted execution environment allows class secret and provisioning key derivation to be protected in the client devices.

According to a fifth aspect, a processor used in a secure server device comprising an interface coupled to the processor is provided. The processor is configured to cause the interface to obtain a public key of a provisioning asymmetric cryptographic key pair, the provisioning asymmetric cryptographic key pair having been generated based on a first symmetric cryptographic key of a client device class identifier. The processor is further configured to utilize the obtained public key of the provisioning asymmetric cryptographic key pair in generation of a second symmetric cryptographic key, and utilize the generated second symmetric cryptographic key in encryption of data to be provisioned to one or more client devices associated with the class identifier. The processor is further configured to cause the interface to send the encrypted data to be provisioned to one or more of the client devices associated with the class identifier.

According to a sixth aspect, a processor used in a secure server device comprising an interface coupled to the processor is provided. The processor is configured to cause the interface to obtain a public key of a provisioning asymmetric cryptographic key pair, the provisioning asymmetric cryptographic key pair having been generated based on a first symmetric cryptographic key of a client device class identifier. The processor is further configured to utilize the obtained public key of the provisioning asymmetric cryptographic key pair in generation of a second symmetric cryptographic key, randomly generate a third symmetric cryptographic key, encrypt data to be provisioned to one or more client devices associated with the class identifier with the randomly generated third symmetric cryptographic key, and utilize the generated second symmetric cryptographic key in encryption of the third symmetric cryptographic key. The processor is further configured to cause the interface to send the encrypted data to be provisioned and the encrypted third symmetric cryptographic key to one or more of the client devices associated with the class identifier.

According to a seventh aspect, a processor used in a client device comprising a transceiver coupled to the processor is provided. The processor is configured to cause the transceiver to receive from a secure server device encrypted data to be provisioned to the client device. The processor is further configured to obtain a private key of a provisioning asymmetric cryptographic key pair, the provisioning asymmetric cryptographic key pair having been generated at the client device based on a first symmetric cryptographic key of a client device class identifier associated with the client device, the first symmetric cryptographic key stored in a secure storage of the client device. The processor is further configured to utilize the obtained private key of the provisioning asymmetric cryptographic key pair in generation of a second symmetric cryptographic key. The processor is further configured to utilize the generated second symmetric cryptographic key in decryption of the encrypted data to be provisioned.

According to an eighth aspect, a processor used in a client device comprising a transceiver coupled to the processor is provided. The processor is configured to cause the transceiver to receive from a secure server device encrypted data to be provisioned to the client device. The processor is further configured to obtain a private key of a provisioning asymmetric cryptographic key pair, the provisioning asymmetric cryptographic key pair having been generated at the client device based on a first symmetric cryptographic key of a client device class identifier associated with the client device, the first symmetric cryptographic key stored in a secure storage of the client device. The processor is further configured to utilize the obtained private key of the provisioning asymmetric cryptographic key pair in generation of a second symmetric cryptographic key. The processor is further configured to utilize the generated second symmetric cryptographic key in decryption of an encrypted third symmetric cryptographic key, and utilize the decrypted third symmetric cryptographic key in the decryption of the data to be provisioned, the encrypted third symmetric cryptographic key having been received from the secure server device by the transceiver.

According to a ninth aspect, a method is provided. The method comprises obtaining, by a secure server device, a public key of a provisioning asymmetric cryptographic key pair, the provisioning asymmetric cryptographic key pair having been generated based on a first symmetric cryptographic key of a client device class identifier. The method further comprises utilizing, by the secure server device, the obtained public key of the provisioning asymmetric cryptographic key pair in generation of a second symmetric cryptographic key. The method further comprises utilizing, by the secure server device, the generated second symmetric cryptographic key in encryption of data to be provisioned to one or more client devices associated with the class identifier. The method further comprises sending the encrypted data to be provisioned from the secure server device to one or more of the client devices associated with the class identifier.

In a further implementation form of the ninth aspect, the method further comprises generating an ephemeral asymmetric cryptographic key pair by the secure server device. The second symmetric cryptographic key is generated based on the obtained public key of the provisioning asymmetric cryptographic key pair and a private key of the generated ephemeral asymmetric cryptographic key pair using a predetermined key-agreement protocol. The method further comprises sending, by the secure server device, a public key of the generated ephemeral asymmetric cryptographic key pair to the one or more of the client devices associated with the class identifier.

In a further implementation form of the ninth aspect, the data to be provisioned comprises at least one of cryptographic key material or executable code.

In a further implementation form of the ninth aspect, the provisioning asymmetric cryptographic key pair comprises an elliptic curve key pair or a Rivest-Shamir-Adleman key pair.

In a further implementation form of the ninth aspect, the predetermined key-agreement protocol comprises a Diffie-Hellman key-agreement protocol.

In a further implementation form of the ninth aspect, the Diffie-Hellman key-agreement protocol comprises an elliptic curve Diffie-Hellman key-agreement protocol.

In a further implementation form of the ninth aspect, the secure server device further comprises a hardware security module.

According to a tenth aspect, a computer program is provided. The computer program comprises program code configured to perform the method according to the ninth aspect, when the computer program is executed on a computing device.

According to an eleventh aspect, a method is provided. The method comprises obtaining, by a secure server device, a public key of a provisioning asymmetric cryptographic key pair, the provisioning asymmetric cryptographic key pair having been generated based on a first symmetric cryptographic key of a client device class identifier. The method further comprises utilizing, by the secure server device, the obtained public key of the provisioning asymmetric cryptographic key pair in generation of a second symmetric cryptographic key. The method further comprises randomly generating a third symmetric cryptographic key by the secure server device. The method further comprises encrypting, by the secure server device, data to be provisioned to one or more client devices associated with the class identifier with the randomly generated third symmetric cryptographic key. The method further comprises utilizing, by the secure server device, the generated second symmetric cryptographic key in encryption of the third symmetric cryptographic key. The method further comprises sending the encrypted data to be provisioned and the encrypted third symmetric cryptographic key from the secure server device to one or more of the client devices associated with the class identifier.

In a further implementation form of the eleventh aspect, the method further comprises generating an ephemeral asymmetric cryptographic key pair by the secure server device. The second symmetric cryptographic key is generated based on the obtained public key of the provisioning asymmetric cryptographic key pair and a private key of the generated ephemeral asymmetric cryptographic key pair using a predetermined key-agreement protocol. The method further comprises sending, by the secure server device, a public key of the generated ephemeral asymmetric cryptographic key pair to the one or more of the client devices associated with the class identifier.

In a further implementation form of the eleventh aspect, the method further comprises utilizing, by the secure server device, white-box cryptography in the encryption of the generated third symmetric cryptographic key.

In a further implementation form of the eleventh aspect, the data to be provisioned comprises at least one of cryptographic key material or executable code.

In a further implementation form of the eleventh aspect, the provisioning asymmetric cryptographic key pair comprises an elliptic curve key pair or a Rivest-Shamir-Adleman key pair.

In a further implementation form of the eleventh aspect, the predetermined key-agreement protocol comprises a Diffie-Hellman key-agreement protocol.

In a further implementation form of the eleventh aspect, the Diffie-Hellman key-agreement protocol comprises an elliptic curve Diffie-Hellman key-agreement protocol.

In a further implementation form of the eleventh aspect, the secure server device further comprises a hardware security module.

According to a twelfth aspect, a computer program is provided. The computer program comprises program code configured to perform the method according to the eleventh aspect, when the computer program is executed on a computing device.

According to a thirteenth aspect, a method is provided. The method comprises receiving, at a client device from a secure server device, encrypted data to be provisioned to the client device. The method further comprises obtaining, by the client device, a private key of a provisioning asymmetric cryptographic key pair, the provisioning asymmetric cryptographic key pair having been generated by the client device based on a first symmetric cryptographic key of a client device class identifier associated with the client device, the first symmetric cryptographic key stored at a secure storage of the client device. The method further comprises utilizing, by the client device, the obtained private key of the provisioning asymmetric cryptographic key pair in generation of a second symmetric cryptographic key. The method further comprises utilizing, by the client device, the generated second symmetric cryptographic key in decryption of the encrypted data to be provisioned.

In a further implementation form of the thirteenth aspect, the method further comprises receiving a public key of an ephemeral asymmetric cryptographic key pair at the client device from the secure server device. The method further comprises generating, by the client device, the second symmetric cryptographic key based on the private key of the generated provisioning asymmetric cryptographic key pair and the received public key of the ephemeral asymmetric cryptographic key pair using a predetermined key-agreement protocol.

In a further implementation form of the thirteenth aspect, the client device further comprises a trusted execution environment for performing cryptographic operations.

According to a fourteenth aspect, a computer program is provided. The computer program comprises program code configured to perform the method according to the thirteenth aspect, when the computer program is executed on a computing device.

According to a fifteenth aspect, a method is provided. The method comprises receiving, at a client device from a secure server device, encrypted data to be provisioned to the client device. The method further comprises obtaining, by the client device, a private key of a provisioning asymmetric cryptographic key pair, the provisioning asymmetric cryptographic key pair having been generated by the client device based on a first symmetric cryptographic key of a client device class identifier associated with the client device, the first symmetric cryptographic key stored at a secure storage of the client device. The method further comprises utilizing, by the client device, the obtained private key of the provisioning asymmetric cryptographic key pair in generation of a second symmetric cryptographic key. The method further comprises utilizing, by the client device, the generated second symmetric cryptographic key in decryption of an encrypted third symmetric cryptographic key, the encrypted third symmetric cryptographic key having been received at the client device from the secure server device. The method further comprises utilizing the decrypted third symmetric cryptographic key in the decryption of the data to be provisioned.

In a further implementation form of the fifteenth aspect, the method further comprises receiving a public key of an ephemeral asymmetric cryptographic key pair at the client device from the secure server device. The method further comprises generating, by the client device, the second symmetric cryptographic key based on the private key of the generated provisioning asymmetric cryptographic key pair and the received public key of the ephemeral asymmetric cryptographic key pair using a predetermined key-agreement protocol.

In a further implementation form of the fifteenth aspect, the method further comprises utilizing, by the client device, white-box cryptography in the decryption of the received encrypted third symmetric cryptographic key.

In a further implementation form of the fifteenth aspect, the client device further comprises a trusted execution environment for performing cryptographic operations.

According to a sixteenth aspect, a computer program is provided. The computer program comprises program code configured to perform the method according to the fifteenth aspect, when the computer program is executed on a computing device.

Many of the attendant features will be more readily appreciated as they become better understood by reference to the following detailed description considered in connection with the accompanying drawings.

### DESCRIPTION OF THE DRAWINGS

In the following, example embodiments are described in more detail with reference to the attached figures and drawings, in which:

FIG. 1A is a block diagram illustrating a secure server device according to an embodiment;

FIG. 1B is a block diagram illustrating a secure server device according to another embodiment;

FIG. 1C is a block diagram illustrating a client device according to an embodiment;

FIG. 1D is a block diagram illustrating a client device according to another embodiment;

FIG. 2 is a diagram illustrating a system according to an embodiment;

FIG. 3A is a diagram illustrating methods according to an embodiment;

FIG. 3B is a diagram illustrating a method according to another embodiment; and

FIG. 3C is a flow diagram illustrating another method according to yet another embodiment.

In the following, identical reference signs refer to identical or at least functionally equivalent features.

### DETAILED DESCRIPTION

In the following description, reference is made to the accompanying drawings, which form part of the disclosure, and in which are shown, by way of illustration, specific aspects in which the present disclosure may be placed. It is understood that other aspects may be utilized and structural or logical changes may be made without departing from the scope of the present disclosure. The following detailed description, therefore, is not to be taken in a limiting sense, as the scope of the present disclosure is defined be the appended claims.

For instance, it is understood that a disclosure in connection with a described method may also hold true for a corresponding device or system configured to perform the method and vice versa. For example, if a specific method step is described, a corresponding device may include a unit to perform the described method step, even if such unit is not explicitly described or illustrated in the figures. On the other hand, for example, if a specific apparatus is described based on functional units, a corresponding method may include a step performing the described functionality, even if such step is not explicitly described or illustrated in the figures. Further, it is understood that the features of the various example aspects described herein may be combined with each other, unless specifically noted otherwise.

Asymmetric cryptography (also known as public key cryptography) refers to a cryptographic technique that involves a pair of keys linked with each other, i.e. a public key and a private key. The public key may be distributed widely, whereas the private key is only known by its owner. Any person can encrypt a message using the public key of the owner (i.e. receiver of the message), but such an encrypted message can only be decrypted with the receiver's private key. Furthermore, the public key can used for authentication, i.e. to verify by anyone that the owner of the corresponding private key sent the message.

Symmetric cryptography refers to a cryptographic technique that involves the use of the same cryptographic key for both encryption of plaintext and decryption of ciphertext. In other words, the cryptographic key of the symmetric cryptography represents a shared secret between two or more parties.

As described in more detail below, the secure server devices 100a, 100b will be utilized in provisioning data to the client devices 110a, 110b during device manufacturing. Such data may include various asset data, including but not limited to: device keys or device key pairs, other cryptographic key material, digital certificates, security policies, device identifiers and credentials. These device keys/key pairs are typically required e.g. to enable various security services offered by the mobile/wearable device. Additionally/alternatively, data to be provisioned may include executable code, e.g. a Trusted Application (TA). These device keys/key pairs (or other data to be provisioned) may be generated using e.g. a cryptographic programming interface, such as that provided by a hardware security module 103a, 103b.

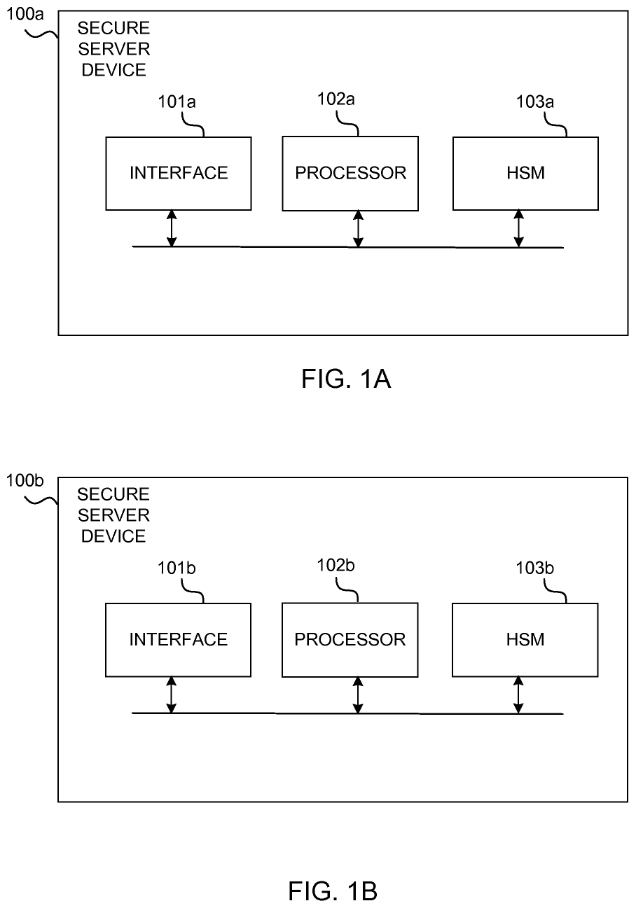

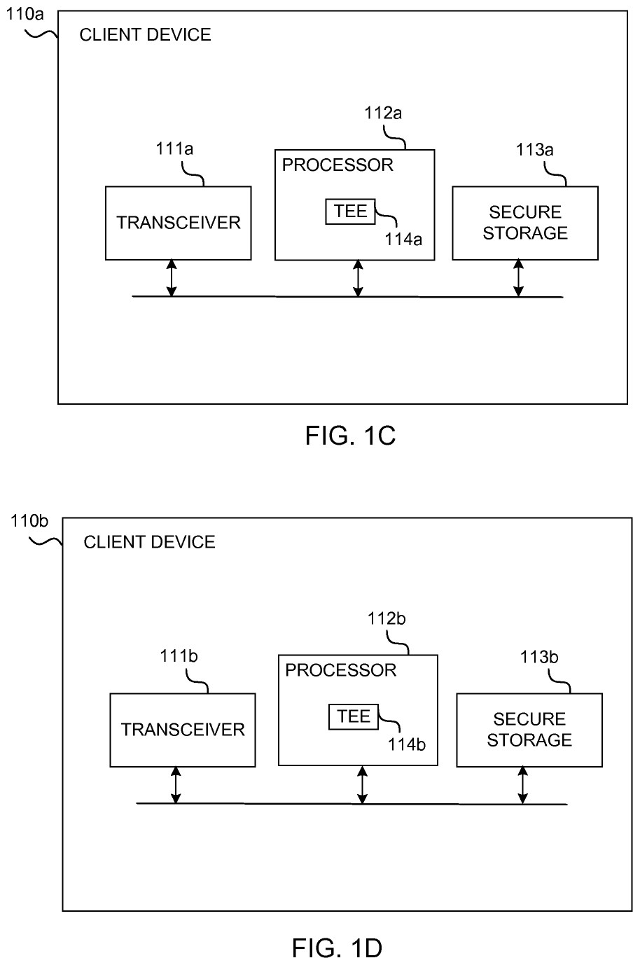

In the following, example embodiments of secure server devices 100a and 100b and client devices 110a and 110b are described based on FIGS. 1A, 1B, 1C and 1D. FIG. 1A shows a secure server device 100a which comprises an interface 101a, a processor 102a, and a optionally a hardware security module (HSM) 103a.

The secure server device 100a may comprise e.g. a manufacturing server that is used in manufacturing client devices, such as mobile devices and/or wearable devices. In other words, the secure server device 100a may be deployed at a manufacturing line for client devices. Here, the term “secure” refers to a trusted server device 100a comprising an element or unit that allows secure handling of sensitive or private data. The secure server device 100a may be implemented e.g. by the inclusion of the hardware security module 103a. Typically, the term “hardware security module” refers to a physical computing device that safeguards and manages digital keys and provides cryptoprocessing. Such a module may provide a secure and certified environment against physical and logical attacks and may comprise e.g. a plug-in card or an external device that attaches directly to the secure server device 100a.

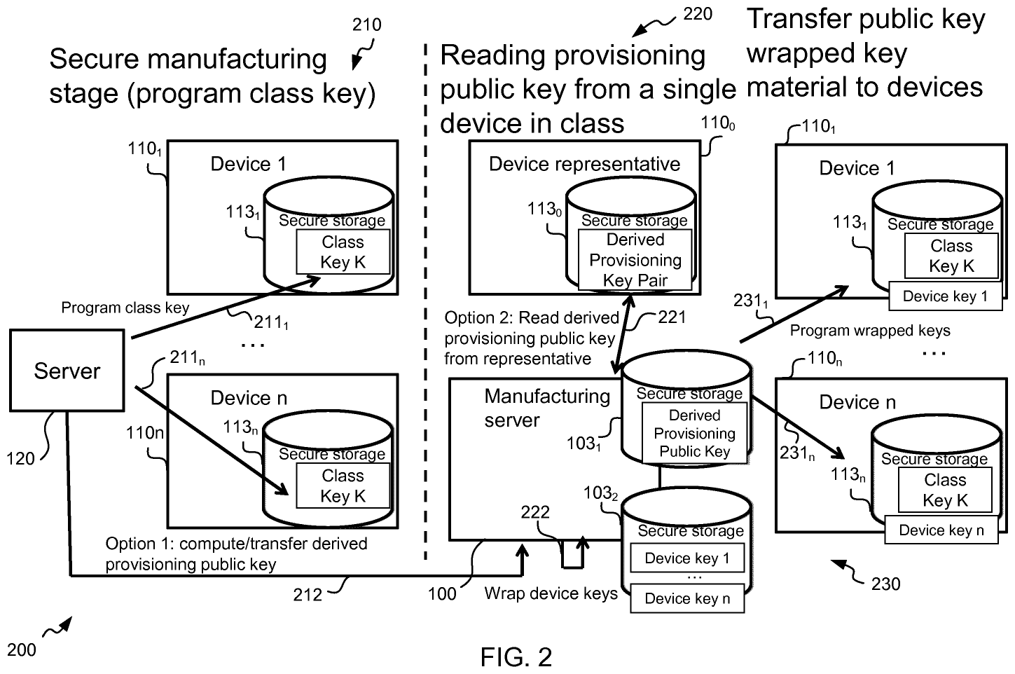

Herein, each client device belongs to a class of client devices. For example, client devices with the same hardware specifications may share the same class. However, in some embodiments it is possible for hardware with different specifications to also have the same class identifier. A client device class is uniquely identified by an associated client device class identifier. Furthermore, each client device class identifier is assigned its own class key (K). The class key K is a symmetric cryptographic key that is the same for all the hardware with the same class identifier. In other words, the class key is a secret cryptographic key shared by all the hardware with the same class manufactured by the hardware vendor. The class key K is typically written into a secure memory area of the client device (such as the secure storage 113a, 113b of FIGS. 1C and 1D) that is accessible by secure hardware (such as the trusted execution environment 114a, 114b of FIGS. 1C and 1D) of the client device. Normal application code cannot access the class key K. The generation of the class key K and its programming into the client devices 110a, 110b may be performed e.g. by the server 120 of FIG. 2.

The interface 101a is configured to obtain (e.g. retrieve or receive) a public key of a provisioning asymmetric cryptographic key pair (PKP). The provisioning asymmetric cryptographic key pair PKP comprises a private key (dₚ) and the public key (Qₚ).

The provisioning asymmetric cryptographic key pair PKP may have been derived from the class key K using a suitable method. For example, in an embodiment, the class key K may be used to derive an elliptic curve (EC) key pair. In another embodiment, the class key K may be used to derive a Rivest-Shamir-Adleman (RSA) key pair. In other words, the provisioning asymmetric cryptographic key pair may comprise e.g. an elliptic curve key pair or a Rivest-Shamir-Adleman key pair.

The derivation of the provisioning asymmetric cryptographic key pair PKP can be done e.g. by the chip manufacturer (e.g. the server 120), or by the client device manufacturer (e.g. the secure server device 100a). The derivation or generation of the provisioning asymmetric cryptographic key pair will be described in more detail in connection with FIG. 2. In other words, the provisioning asymmetric cryptographic key pair has been generated based on the first symmetric cryptographic key of the client device class identifier.

The processor 102a may optionally be configured to generate an ephemeral asymmetric cryptographic key pair. The ephemeral asymmetric cryptographic key pair comprises a private key (dₑ) and a public key (Qₑ). The processor 102a may include e.g. one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

The processor 102a is further configured to establish a shared secret, i.e. a provisioning session key (PSK) between the secure server device 100a and the client device 110a. In other words, the processor 102a is further configured to utilize the obtained public key Qₚ of the provisioning asymmetric cryptographic key pair in the generation of a second symmetric cryptographic key (i.e. provisioning session key PSK).

For example, when the ephemeral asymmetric cryptographic key pair has been generated, this may be implemented so that the processor 102a generates the second symmetric cryptographic key PSK based on the obtained public key Qₚ of the provisioning asymmetric cryptographic key pair and the private key dₑ of the generated ephemeral asymmetric cryptographic key pair, e.g. by using a predetermined key-agreement protocol. The key-agreement protocol may comprise a Diffie-Hellman key-agreement protocol, such as an elliptic curve Diffie-Hellman (ECDH) key-agreement protocol. In other words, the ephemeral key pair may be used together with the provisioning key pair PKP to agree on a shared secret PSK using e.g. a Diffie-Hellman key agreement, such as the ECDH.

The processor 102a is further configured to utilize the generated second symmetric cryptographic key PSK in encryption of the data to be provisioned to the client device 110a. For example, the processor 102a may utilize the generated second symmetric cryptographic key PSK to securely wrap the data to be provisioned. After the encryption, the interface 101a is further configured to send the encrypted data to be provisioned to the client device 110a. When the ephemeral asymmetric cryptographic key pair has been generated, the interface 101a may optionally be configured to also send the public key Qₑ of the generated ephemeral asymmetric cryptographic key pair to the client device 110a.

FIG. 1B shows a secure server device 100b which comprises an interface 101b, a processor 102b, and a optionally a hardware security module (HSM) 103b. Similar to the embodiment of FIG. 1A, the processor 102b is configured to utilize the obtained public key Qₚ of the provisioning asymmetric cryptographic key pair (PKP) in generation of the second symmetric cryptographic key (provisioning session key, PSK), optionally utilizing the ephemeral asymmetric cryptographic key pair and a suitable key-agreement protocol as in the embodiment of FIG. 1A.

However, in contrast to the embodiment of FIG. 1A, the processor 102b is configured to randomly generate a third symmetric cryptographic key (or in other words, a shared key encryption key, KEK).

Further in contrast to the embodiment of FIG. 1A, the processor 102b is configured to encrypt the data to be provisioned to the client device 110b with the randomly generated third symmetric cryptographic key KEK. As described above, in the embodiment of FIG. 1A, the data to be provisioned was instead encrypted or wrapped with the second symmetric cryptographic key PSK.

Further in contrast to the embodiment of FIG. 1A, the processor 102b is configured to use the second symmetric cryptographic key PSK to encrypt the third symmetric cryptographic key KEK after its use to encrypt the data to be provisioned. The thus encrypted third symmetric cryptographic key KEK (or in other words, an encrypted provisioning key, PEK) may be still further encrypted by the processor 102b with white-box cryptography.

Further in contrast to the embodiment of FIG. 1A, the interface 101b is further configured to send also the encrypted third symmetric cryptographic key PEK to the client device 110b.

Otherwise, the elements, features and parameters (such as the various cryptographic keys, identifiers, and data to be provisioned) of the secure server device 100a and the secure server device 100b are identical or at least functionally equivalent so their descriptions are not repeated here in detail.

FIG. 1C shows a client device 110a which comprises an transceiver 111a, a processor 112a, a secure storage 113a, and optionally secure hardware, such as a trusted execution environment (TEE) 114a.

The client device 110a may be any of various types of mobile and/or wearable devices used directly by an end user entity and capable of communication in a wireless network, such as user equipment (UE). Such devices include but are not limited to smartphones, tablet computers, smart watches, lap top computers, Internet-of-Things (IoT) devices etc.

Furthermore, the client device 110a may comprise secure hardware, such as a trusted execution environment (TEE) 114a for performing cryptographic operations, such as encryption and/or decryption related operations. Typically, the trusted execution environment refers to a secure area in a processor (such as the processor 112a), or a processor (such as the processor 112a) executing in a secure mode, or the like. It may be used e.g. to guarantee that code and data loaded inside are isolated from other applications and protected with respect to confidentiality and integrity. The trusted execution environment 114a may be integrated with the secure storage 113a, i.e. only the TEE may be allowed to access the secure storage 113a containing device secrets.

The secure storage 113a is configured to store the first symmetric cryptographic key (i.e. class key K described above in more detail) of the client device class identifier associated with the client device 110a.

It is to be noted that the various cryptographic keys, identifiers, and data to be provisioned used by the client device 110a are identical or at least functionally equivalent to those used by the secure server device 100a so their descriptions are not repeated here in detail.

The transceiver 111a is configured to receive from the secure server device 100a the encrypted data to be provisioned to the client device 110a.

The processor 112a is configured to obtain the private key dₚ of the provisioning asymmetric cryptographic key pair PKP. The provisioning asymmetric cryptographic key pair PKP is generated or has been previously generated at the client device 110a based on the first symmetric cryptographic key K stored in the secure storage 113a. If the data provisioning has been done before for the client device 110a, then the provisioning asymmetric cryptographic key pair PKP has been generated during this first provisioning. In an example, the client device 110a may store the generated provisioning asymmetric cryptographic key pair PKP e.g. to the secure storage 113a at the first data provisioning, and the during the following data provisionings the generated provisioning asymmetric cryptographic key pair PKP may be obtained from the secure storage 113a. In other words, the generation of the provisioning asymmetric cryptographic key pair PKP may be performed only once per client device 110a.

The processor 112a is further configured to utilize the obtained private key dₚ of the provisioning asymmetric cryptographic key pair PKP in generation of the second symmetric cryptographic key PSK. For example, this may be implemented so that the transceiver 111a receives the public key Qₑ of the ephemeral asymmetric cryptographic key pair from the secure server device 100a, and the processor 112a generates the second symmetric cryptographic key PSK based on the private key dₚ of the generated provisioning asymmetric cryptographic key pair PKP and the received public key Qₑ of the ephemeral asymmetric cryptographic key pair using a predetermined key-agreement protocol. As before, the key-agreement protocol may comprise the Diffie-Hellman key-agreement protocol, such as the elliptic curve Diffie-Hellman (ECDH) key-agreement protocol.

The processor 112a is further configured to utilize the generated second symmetric cryptographic key PSK in decryption of the encrypted data to be provisioned that was received from the secure server device 100a.

FIG. 1D shows a client device 110b which comprises an transceiver 111b, a processor 112b, a secure storage 113b, and optionally secure hardware, such as a trusted execution environment (TEE) 114b.

In contrast to the embodiment of FIG. 1C, the transceiver 111b is also configured to receive the encrypted third symmetric cryptographic key PEK from the secure server device 100b. Further in contrast to the embodiment of FIG. 1C, the processor 112b is configured to utilize the generated second symmetric cryptographic key PSK in decryption of the encrypted third symmetric cryptographic key (PEK) thereby obtaining the decrypted third symmetric cryptographic key (KEK), whereas in the embodiment of FIG. 1C the PSK was used to decrypt the encrypted data to be provisioned.

Further in contrast to the embodiment of FIG. 1C, the processor 112b is configured to utilize the decrypted third symmetric cryptographic key KEK in the decryption of the data to be provisioned.

Otherwise, the elements, features and parameters (such as the various cryptographic keys, identifiers, and data to be provisioned) of the client device 110a and the client device 110b are identical or at least functionally equivalent so their descriptions are not repeated here in detail.

FIG. 2 shows a diagram illustrating a system 200 according to an embodiment. The system 200 comprises a server 120 (e.g. a chip manufacturer server), a secure server device 100, a client device 110₀, and client devices 110₁-110ₙ.

In an embodiment, the elements, features and parameters (such as the various cryptographic keys, identifiers, and data to be provisioned) of the secure server device 100 are identical or at least functionally equivalent to those of the secure server device 100a, and the elements, features and parameters of the client devices 110₁-110ₙ are identical or at least functionally equivalent to those of the client devices 110a. In another embodiment, the elements, features and parameters of the secure server device 100 are identical or at least functionally equivalent to those of the secure server device 100b, and the elements, features and parameters of the client devices 110₁-110ₙ are identical or at least functionally equivalent to those of the client device 110b. Accordingly, their descriptions are not repeated here in detail.

As shown in FIG. 2, a secure manufacturing stage 210 involves the class key K being securely programmed to the client devices 110₁-110ₙ in operations 211i to 211ₙ. The secure manufacturing stage 210 needs to be done once per client device class. As discussed above, the class key K is typically written into secure memory areas of the client devices 110₁-110ₙ (such as the secure storage 113₁-113ₙ) that is accessible by secure hardware (such as the trusted execution environment) of the client devices 110₁-110_{g}. Normal application code cannot access the class key K.

Stages 220 and 230 involve secure transfer of assets/data to be provisioned from the secure server device 100 to the client devices 110₁-110ₙ. Stages 220 and 230 need to be done once per client device.

The derivation of the PKP can be done e.g. by a chip manufacturer, or by a client device manufacturer using a single client device 113₀ belonging to the specific class. In the former case, the chip manufacturer derives the PKP in a secure environment (e.g. server 120) in which the class key K is available. In the latter case, the client device manufacturer may load a special trusted PKP-generation application to a single client device 113₀. This trusted application has access to the class key K and derives the PKP in this client device 113₀. In both cases, the key derivation needs to be done only once per device class. The public key part the PKP is securely transferred (operation 212 or 221) to a trusted server (i.e. secure server device 100) that makes use of it accordingly.

The PKP is then used to wrap/encrypt (operation 222) an asset in the trusted server 100, the wrapped/encrypted asset is transferred (operations 231ᵢ to 231ₙ) to the client devices 110₁-110ₙ, and the client devices 110₁-110ₙ unwrap/decrypt the asset with the PKP. In addition to transferring the wrapped/encrypted asset, also additional security parameters may need to be transferred, including the public key Qₑ of the ephemeral key pair, potential initialization vectors (IVs) used during wrapping/encrypting the assets, and/or plain data (such as a device certificate chain).

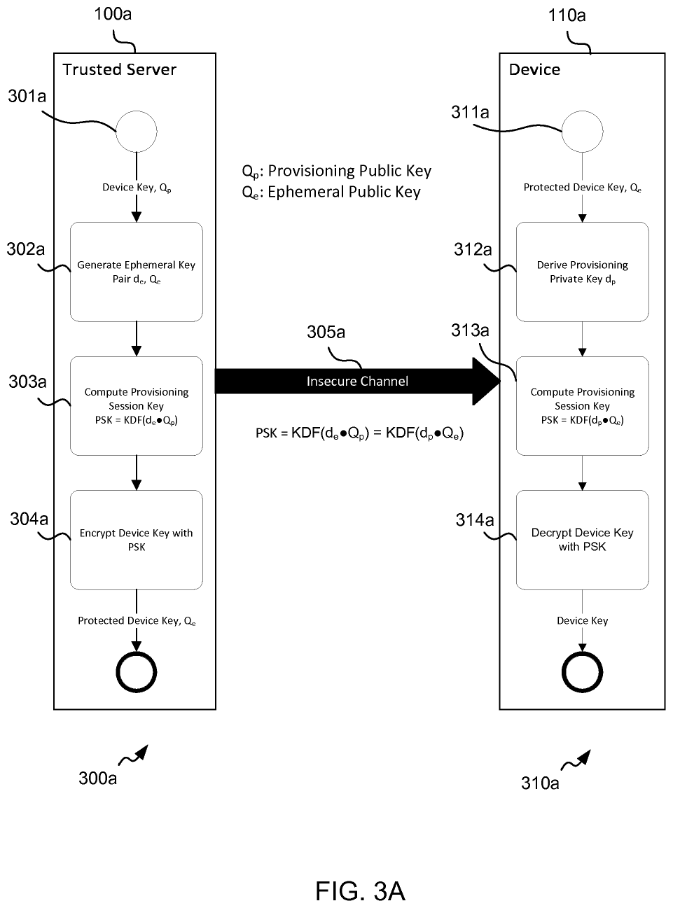

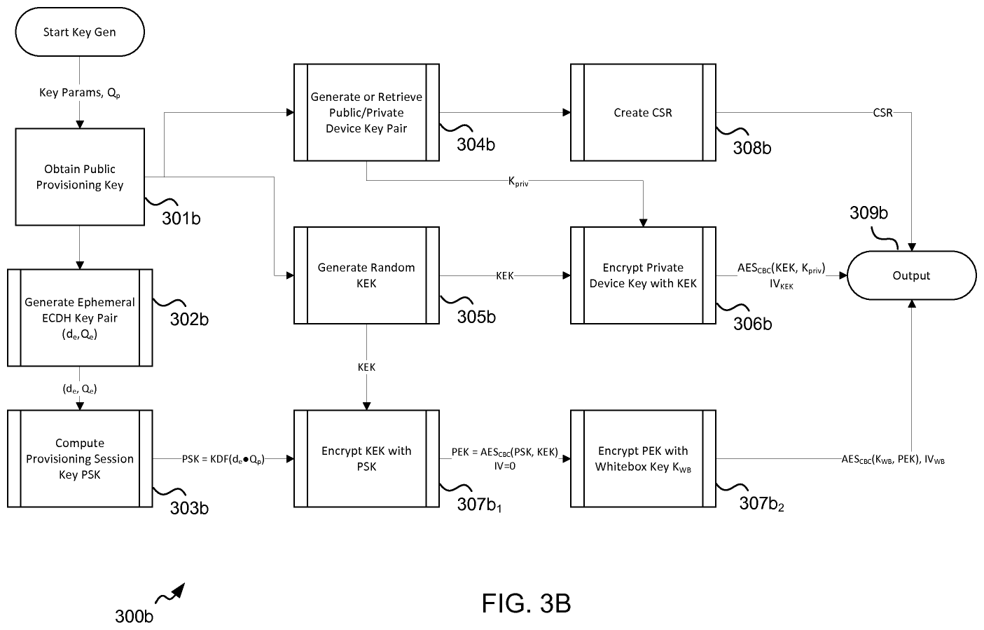

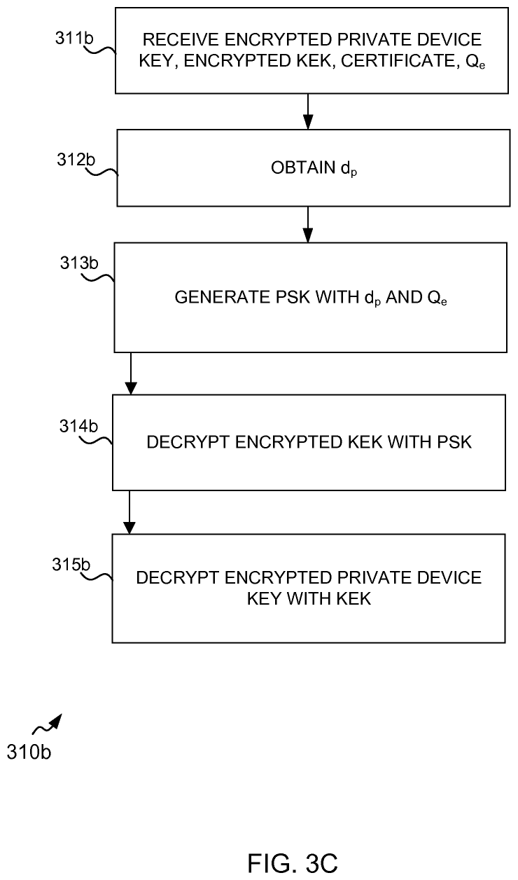

FIG. 3A shows a diagram 300a of an example method according to an embodiment.

The method 300a comprises obtaining, by a secure server device, a public key of a provisioning asymmetric cryptographic key pair PKP, the provisioning asymmetric cryptographic key pair PKP having been generated based on a first symmetric cryptographic key K of a client device class identifier, step 301a.

The method 300a further comprises generating an ephemeral asymmetric cryptographic key pair by the secure server device, step 302a.

The method 300a further comprises generating a second symmetric cryptographic key PSK based on the obtained public key Qₚ of the provisioning asymmetric cryptographic key pair and a private key dₑ of the generated ephemeral asymmetric cryptographic key pair using a predetermined key-agreement protocol, step 303a.

The method 300a further comprises utilizing, by the secure server device, the generated second symmetric cryptographic key in encryption of data to be provisioned to one or more client devices associated with the class identifier, step 304a.

The method 300a further comprises sending the encrypted data to be provisioned and the public key Qₑ of the generated ephemeral asymmetric cryptographic key pair from the secure server device to one or more of the client devices associated with the class identifier, step 305a.

The method 300a may be performed by the secure server device 100a. Further features of the method 300a directly result from the functionalities of the secure server device 100a. The method 300a can be performed by a computer program.

FIG. 3A further shows a diagram 310a of another example method according to same the embodiment.

The method 310a comprises receiving, at the client device from the secure server device, the public key Qₑ of the ephemeral asymmetric cryptographic key pair and the encrypted data to be provisioned to the client device, step 311a.

The method 310a further comprises obtaining, by the client device, the private key dₚ of the provisioning asymmetric cryptographic key pair, step 312a. The provisioning asymmetric cryptographic key pair has been generated by the client device based on the first symmetric cryptographic key (class key K) of the client device class identifier associated with the client device, which first symmetric cryptographic key is stored at the secure storage of the client device.

The method 310a further comprises generating, by the client device, the second symmetric cryptographic key PSK based on the private key dₚ of the generated provisioning asymmetric cryptographic key pair and the received public key Qₑ of the ephemeral asymmetric cryptographic key pair using a predetermined key-agreement protocol, step 313a.

The method 310a further comprises utilizing, by the client device, the generated second symmetric cryptographic key PSK in decryption of the encrypted data to be provisioned, step 314a.

The method 310a may be performed by the client device 110a. Further features of the method 310a directly result from the functionalities of the client device 110a. The method 310a can be performed by a computer program.

FIG. 3B shows a diagram of an example method 300b according to another embodiment.

The method 300b comprises obtaining, by a secure server device, a public key of a provisioning asymmetric cryptographic key pair PKP, the provisioning asymmetric cryptographic key pair PKP having been generated based on a first symmetric cryptographic key K of a client device class identifier, step 301b.

The method 300b further comprises generating an ephemeral asymmetric cryptographic key pair by the secure server device, step 302b.

The method 300b further comprises generating a second symmetric cryptographic key PSK based on the obtained public key Qₚ of the provisioning asymmetric cryptographic key pair and a private key dₑ of the generated ephemeral asymmetric cryptographic key pair using a predetermined key-agreement protocol, step 303b.

The method 300b further comprises obtaining (generating or retrieving) data to be provisioned (private device key Kₚᵣᵢᵥ) to one or more client devices associated with the class identifier, step 304b.

The method 300b further comprises randomly generating a third symmetric cryptographic key KEK by the secure server device, step 305b.

The method 300b further comprises encrypting, by the secure server device, the data to be provisioned with the randomly generated third symmetric cryptographic key KEK, step 306b.

The method 300b further comprises utilizing, by the secure server device, the generated second symmetric cryptographic key PSK in encryption of the third symmetric cryptographic key (KEK), thus obtaining the encrypted third symmetric cryptographic key (PEK), step 307b₁.

Optionally, the method 300b further comprises utilizing, by the secure server device, white-box cryptography in the encryption of the generated third symmetric cryptographic key, step 307b₂.

Optionally, the method 300b further comprises creating a certificate signing request (CSR), step 308b.

The method 300b further comprises sending the encrypted data to be provisioned and the encrypted third symmetric cryptographic key from the secure server device to one or more of the client devices associated with the class identifier, step 309b.

The method 300b may be performed by the secure server device 100b. Further features of the method 300b directly result from the functionalities of the secure server device 100b. The method 300b can be performed by a computer program.

FIG. 3C shows a flow diagram 310b of an example method according to yet another embodiment.

The method 310b comprises receiving, at the client device from the secure server device, the public key Qₑ of the ephemeral asymmetric cryptographic key pair, the encrypted third symmetric cryptographic key (PEK), and the encrypted data to be provisioned to the client device, step 311b.

The method 310b further comprises obtaining, by the client device, the private key dₚ of the provisioning asymmetric cryptographic key pair, step 312b. The provisioning asymmetric cryptographic key pair has been generated by the client device based on the first symmetric cryptographic key (class key K) of the client device class identifier associated with the client device, which first symmetric cryptographic key is stored at the secure storage of the client device.

The method 310b further comprises generating, by the client device, the second symmetric cryptographic key PSK based on the private key dₚ of the generated provisioning asymmetric cryptographic key pair and the received public key Qₑ of the ephemeral asymmetric cryptographic key pair using a predetermined key-agreement protocol, step 313b.

The method 310b further comprises utilizing, by the client device, the generated second symmetric cryptographic key PSK (and optionally white-box cryptography) in decryption of an encrypted third symmetric cryptographic key (PEK) to obtain the decrypted third symmetric cryptographic key (KEK), step 314b.

The method 310b further comprises utilizing the decrypted third symmetric cryptographic key (KEK) in the decryption of the data to be provisioned, step 315b.

The method 310b may be performed by the client device 110b. Further features of the method 310b directly result from the functionalities of the client device 110b. The method 310b can be performed by a computer program.

In other words, the process of FIGS. 3B and 3C may start with the generation (or retrieval) of the device key pair, the generation of the shared key encryption key (KEK), and the generation of the ephemeral key pair (EKP) that is to be used with ECHD. First, the device key pair may be used to generate a certificate signing request (CSR) that can be e.g. in PKCS #10 format. The CSR may be used to enroll a device certificate from a public key infrastructure (PKI) system (i.e., from a certification authority). Then, the KEK is used wrap/encrypt the private device key. Then, the ephemeral key pair's private key Qₑ is used together with PKP's public key dₚ to derive the PSK (e.g. by using the ECDH key agreement). The PSK is then used to wrap/encrypt the KEK resulting in the encrypted provisioning key (PEK). An exclusive or (XOR) may be used for this (i.e. OneTimePad, OTP), but other encryption schemes may be used as well. Finally, the PEK is encrypted using white-box encryption. The device certificate (with the whole certificate chain), encrypted private key, and encrypted KEK (with PSK and white-box encryption) form a data blob that will be used to provision the device key pair with the device certificate chain to the client device. The data blob (i.e. output) may also contain additional data fields, such as initialization vectors (IVs) used in different wrapping/encryption steps, and the public key Qₑ of the ephemeral EPK.

After decrypting the data to be provisioned (e.g. the private device key), the client device may store the data to be provisioned and optionally the device certificate (chain) into a secure location and limit it use as appropriate.

The disclosure allows a non-trusted manufacturing facility equipped with the secure server device to establish a secure data provisioning channel from the secure server device to trusted hardware in client devices, thereby avoiding security issues associated with provisioning of data in the client device during device manufacturing, such as how to encrypt the data to be provisioned so that only the target client device is able to decrypt the data, and how to authenticate the target client device.

In the disclosure, the class key K is used to generate a provisioning key pair (PKP), where the private key part is only known by the client device, and the public key part is transferred to the secure server device. The PKP is then used e.g. with Elliptic Curve Diffie-Hellman (ECDH) method to derive a provisioning shared secret (PSK), which can be used to secure the transfer of the data to be provisioned from the secure server device to the client device. Since only the client device has access to the private key part of the PKP, only it can obtain the asset in plain text. This process also implicitly authenticates the client device as the secure server device knows that the corresponding private key is only available in authenticated client devices.

Furthermore, a single public key per device class needs to be derived and/or obtained, which will be imported to the secure server device. Furthermore, the disclosure is readily deployable since chip manufacturers typically pre-program class secrets in their chips. Furthermore, key derivation can be diversified to allow multiple provisioning keys for multiple use cases. Furthermore, even if one provisioning session key is compromised, it does not allow access to any other device keys.

The functionality described herein can be performed, at least in part, by one or more computer program product components such as software components. According to an embodiment, the client devices 110a, 110b and/or secure server devices 100a, 100b comprise a processor configured by the program code when executed to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), and Graphics Processing Units (GPUs).

Any range or device value given herein may be extended or altered without losing the effect sought. Also any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the embodiments described above may be combined with aspects of any of the other embodiments described to form further embodiments without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A secure server device comprising:
an interface configured to obtain a public key of a provisioning asymmetric cryptographic key pair, wherein the provisioning asymmetric cryptographic key pair is based on a first symmetric cryptographic key of a client device class identifier; and
a processor coupled to the interface and configured to:
generate an ephemeral asymmetric cryptographic key pair;
generate, based on the public key of the provisioning asymmetric cryptographic key pair and a private key of the ephemeral asymmetric cryptographic key pair using a predetermined key-agreement protocol, a second symmetric cryptographic key; and
encrypt, using the second symmetric cryptographic key, data to be provisioned to a client devices associated with the client device class identifier to obtain encrypted data,
wherein the interface is further configured to send the encrypted data and a public key of the ephemeral asymmetric cryptographic key pair to the client devices.

2. (canceled)

3. The secure server device of claim 1, wherein the data comprises cryptographic key material.

4. The secure server device claim 1, wherein the provisioning asymmetric cryptographic key pair comprises an elliptic curve key pair.

5. The secure server device of claim 1, wherein the predetermined key-agreement protocol comprises a Diffie-Hellman key-agreement protocol.

6. The secure server device claim 5, wherein the Diffie-Hellman key-agreement protocol comprises an elliptic curve Diffie-Hellman key-agreement protocol.

7. The secure server device of claim 1, further comprising a hardware security system configured to allow a secure and certified environment.

8.-15. (canceled)

16. A client device comprising:
a secure storage configured to store a first symmetric cryptographic key of a client device class identifier associated with the client device;
a transceiver coupled to the secure storage and configured to:
receive, from a secure server device, a public key of an ephemeral asymmetric cryptographic key pair; and
receive, from the secure server device, encrypted data; and
a processor coupled to the secure storage and the transceiver and configured to:
generate a provisioning asymmetric cryptographic key pair based on the first symmetric cryptographic key;
obtain a private key of the provisioning asymmetric cryptographic key pair;
generate a second symmetric cryptographic key based on the private key of the provisioning asymmetric cryptographic key pair and the public key of the ephemeral asymmetric cryptographic key pair using a predetermined key-agreement protocol; and
decrypt, using the second symmetric cryptographic key, the encrypted data.

17. (canceled)

18. The client device of claim 16, further comprising a trusted execution environment configured to perform cryptographic operations.

19.-26. (canceled)

27. A method implemented by a secure server device, comprising:
obtaining a public key of a provisioning asymmetric cryptographic key pair, wherein the provisioning asymmetric cryptographic key pair is based on a first symmetric cryptographic key of a client device class identifier;
generating an ephemeral asymmetric cryptographic key pair;
generating, based on the public key of the provisioning asymmetric cryptographic key pair and a private key of the ephemeral asymmetric cryptographic key pair using a predetermined key-agreement protocol, a second symmetric cryptographic key;
encrypting, using the second symmetric cryptographic key, data to be provisioned to a client device associated with the client device class identifier to obtain encrypted data; and
sending the encrypted data and a public key of the ephemeral asymmetric cryptographic key pair the client device.

28.-34. (canceled)

35. The method of claim 27, wherein the predetermined key-agreement protocol comprises a Diffie-Hellman key-agreement protocol.

36. The method of claim 35, wherein the Diffie-Hellman key-agreement protocol comprises an elliptic curve Diffie-Hellman key-agreement protocol.

37. The method of claim 27, wherein the data comprises cryptographic key material.

38. The method of claim 27, wherein the data comprises executable code.

39. The method of claim 27, wherein the provisioning asymmetric cryptographic key pair comprises an elliptic curve key pair.

40. The method of claim 27, wherein the provisioning asymmetric cryptographic key pair comprises a Rivest-Shamir-Adleman key pair.

41. The client device of claim 18, wherein the trusted execution environment is configured to allow class secret and provisioning key derivation to be protected.

42. The client device of claim 18, wherein the trusted execution environment is integrated with the secure storage.

43. The secure server device of claim 7, wherein the hardware security system is further configured to provide a cryptographic programming interface.

44. The secure server device of claim 1, wherein the data comprises executable code.

45. The secure server device of claim 1, wherein the provisioning asymmetric cryptographic key pair comprises a Rivest-Shamir-Adleman key pair.
